(19) United States
(12) Patent Application Publication
(10) Pub. No.: US 2026/0225280 A1
(43) Pub. Date: Aug. 6, 2026

(54) A HANDHELD BATTERY POWERED CHAINSAW WITH A CENTRIFUGAL CLUTCH

(71) Applicant: HUSQVARNA AB, Huskvarna (SE)

(72) Inventor: Johannes PETTERSSON, Huskvarna (SE)

(21) Appl. No.: 19/152,196

(22) PCT Filed: Dec. 20, 2023
(86) PCT No.: PCT/SE2023/051291

§ 371 Date: Jul. 30, 2025

(30) Foreign Application Priority Data
Jan. 30, 2023 (SE) 2350081-2

(51) Int. Cl. B27B 17/10; B27B 17/08

(52) U.S. Cl. CPC B27B 17/10; B27B 17/083

(57) ABSTRACT

A handheld battery-powered chainsaw comprises an electric motor (22); and a transmission arrangement (28) coupled to the electric motor (22), the transmission arrangement (28) comprising a saw chain drive sprocket (32) configured to mesh with and drive a saw chain, wherein the transmission arrangement (28) further comprises a centrifugal clutch comprising a drive member (36) configured to receive rotary power from the electric motor (22), and a clutch drum (38) configured to variably engage with the drive member (36) to be rotated by the drive member (36) about a rotation axis (A) and thereby transmit rotary power to the saw chain (16). The transmission arrangement (28) further comprises a brake arrangement comprising a brake drum (40a) rotationally locked, with regard to the rotation axis (A), to the clutch drum (38) via a first keyed interface (44).

### FIELD OF THE INVENTION

The present invention relates to a handheld battery-powered chainsaw.

### BACKGROUND

Chainsaws have been known for the last 100 years or so. Due to considerations of weight vs power and operation time, most chainsaws are still powered by internal combustion engines of two-stroke type, but battery powered chainsaws are becoming increasingly popular. However, obtaining high output power, high cutting efficiency and high usability without compromising other aspects of the chainsaw, such as weight or battery time, still remains a challenge. Moreover, there is an incessant strive to make chainsaws safer and easier to use, and easier to service and maintain.

### SUMMARY

It is an object of the present invention to solve, or at least mitigate, parts or all of the above mentioned problems. To this end, there is provided a handheld battery-powered chainsaw comprising an electric motor and a transmission arrangement coupled to the electric motor, the transmission arrangement comprising a saw chain drive sprocket configured to mesh with and drive a saw chain, wherein the electric motor is configured to drive the saw chain via the transmission arrangement, wherein the transmission arrangement further comprises a centrifugal clutch comprising a drive member configured to receive rotary power from the electric motor and a clutch drum configured to variably engage with the drive member to be rotated by the drive member about a rotation axis and thereby transmit rotary power to the saw chain; the transmission arrangement further comprising a brake arrangement comprising a brake drum rotationally locked, with regard to the rotation axis, to the clutch drum via a first keyed interface. Even though conventionally, a centrifugal clutch is generally not used in a battery-powered chainsaw, because contrary to a combustion engine-powered chainsaw, the electric motor of a battery-powered chainsaw does not need to be kept running between cuts, the centrifugal clutch nevertheless provides other benefits. Most notably, the centrifugal clutch makes it easier to (re-)start the saw chain when the saw chain is already in engagement with the material to be cut. One reason is that a rotational inertia built up by a rotor of the electric motor may contribute to starting the chain upon engagement of the centrifugal clutch. Moreover, the combination of a clutch drum and a separate brake drum increases the rotational inertia of the chainsaw, which reduces the risk that the chain gets stuck during a cut in the first place, and also further facilitates re-starting the saw chain after getting stuck. At the same time, the geometric and structural separation of the brake from the clutch also provides additional freedom in the positioning of other elements, such as further elements of a brake arrangement, which enables a compact chainsaw design. Such further elements of a brake arrangement may comprise, for example, a brake band configured to, responsive to actuation of a brake actuator, apply a clamping force on a radially outer face of the brake drum. The brake actuator may comprise a kick-back brake lever configured as a hand guard in front of a handle of the chainsaw. According to embodiments, the brake drum may be made of metal, such as steel. The first keyed interface facilitates separating the clutch drum from the brake drum, which facilitates servicing the chainsaw. The separability also enables replacing only one of the clutch drum and the brake drum, as the respective drums are exposed to different amounts of wear. According to embodiments, the drive member of the centrifugal clutch may be rotationally fixed to the electric motor. Similarly, the clutch drum may be rotationally fixed to the saw chain drive sprocket. According to further embodiments, the drive member may be fixedly attached to an output shaft of the electric motor. According to embodiments, the chainsaw may comprise a battery compartment configured to receive a battery for powering the chainsaw. Alternatively or additionally, the chainsaw may be configured to be connected to e.g. a backpack battery. A typical suitable DC battery voltage range for providing power to the electric motor may be between 18V and 100V, and more preferably, between about 36V and about 72V. The electric motor may be configured to provide an output power in an exemplary power range of e.g. 1.8 kW-3.5 kW. According to embodiments, the centrifugal clutch may be configured to provide a clutch engagement speed, i.e. a rotational speed at which the drive member engages with the clutch drum, of between 2000 rpm and 7000 rpm, more preferably, between 3000 rpm and 6000 rpm, and even more preferred, between 4500 and 5800 rpm.

According to embodiments, the first keyed interface may be shaped to enable axial translation, along the rotation axis (A), of the brake drum in relation to the clutch drum. Such a configuration relaxes the manufacturing tolerances of the transmission arrangement.

According to embodiments, the first keyed interface may comprise splines. Typically, splines of one key interface part may be shaped to mate with grooves of the other, mating, key interface part of the first keyed interface.

According to embodiments, the clutch drum may comprise a male key interface part, and the brake drum may comprise a female key interface part mating with the male key interface part of the clutch drum. For example, the female key interface part may comprise grooves, and the male key interface part may comprise splines mating with the grooves of the female key interface. Alternatively, the clutch drum may comprise a female key interface part, and the brake drum may comprise a male key interface part mating with the female key interface part of the clutch drum.

According to embodiments, the saw chain drive sprocket may be rotationally locked to the clutch drum via a second keyed interface. Such an arrangement facilitates replacing the saw chain drive sprocket. The second keyed interface may rotationally lock the saw chain drive sprocket to the clutch drum either by direct engagement, or via an intermediate part, such as by engaging in a keyed manner with the brake drum, which is in turn rotationally locked to the clutch drum.

According to embodiments, the second keyed interface may be configured to enable axial translation of the saw chain drive sprocket in relation to the clutch drum. Such an arrangement minimizes any axial load in the engagement between the saw chain and the saw chain drive sprocket, which reduces wear and increases the service life of the saw chain drive sprocket as well as the saw chain.

According to embodiments, the saw chain drive sprocket may comprise a female key interface part mating with a male key interface part of one of the clutch drum and the brake drum. For example, the second keyed interface may comprise grooves mating with splines of the clutch drum.

According to embodiments, the male key interface of the clutch drum may mate with a female key interface part of the saw chain drive sprocket. Thereby, only one key interface need to be formed on the clutch drum, which simplifies manufacture.

According to embodiments, the sprocket may be a rim-type sprocket.

According to embodiments, the saw chain drive sprocket may be arranged at an axial position, along the rotation axis, between the clutch drum and the electric motor. Such an arrangement positions the chain drive sprocket closer to the lateral centre of the chainsaw, which may be particularly well suited for compact chainsaws. Moreover, the clutch drum may protect any transmission cover, as the case may be, from being damaged by the saw chain in the event that the saw chain would derail. The clutch drum may be open towards the distal side, i. e. the side facing away from the electric motor, to enable receiving the drive member via the distal side.

According to embodiments, the saw chain drive sprocket may be arranged at an axial position, along the rotation axis, between the clutch drum and the brake drum. Such an arrangement maintains the saw chain in a well-defined position, for example in the event of derailing.

According to embodiments, the brake drum may be arranged at an axial position, along the rotation axis, between the clutch drum and the electric motor. Such an arrangement positions the chain drive sprocket closer to the lateral centre of the chainsaw, which may be particularly well suited for compact chainsaws. Moreover, any further elements of the brake arrangement, for example any brake band or elements used for actuating the brake band, do not need to be disassembled to remove the clutch drum, which facilitates servicing the chainsaw.

According to embodiments, the brake drum may be arranged at an axial position, along the rotation axis, between the saw chain drive sprocket and the electric motor. Thereby, any further elements of the brake arrangement, for example any brake band or elements used for actuating the brake band, do not need to be disassembled to replace the saw chain drive sprocket, which facilitates servicing the chainsaw.

According to embodiments, the transmission arrangement may further comprise a worm screw in driving engagement with a saw chain oil pump, wherein the worm screw is rotationally locked to the brake drum via a third keyed interface.

According to embodiments, the centrifugal clutch may be a slip clutch. As understood herein, a slip clutch is a clutch which allows, or may be brought to a state in which it allows, the drive member and the clutch drum to slip in relation to each other, and thereby transfer a torque via the slipping engagement, wherein the transferred torque is sufficient to drive the saw chain if the saw chain is unloaded. When set in motion, the gradual, slipping engagement of the clutch may enable a progressively increasing power transfer without any drop in the electric motor's rotational speed. This makes it easier to (re-)start the chain when already in engagement with the material to be cut, because the rotational speed will not drop to zero. Moreover, the slip clutch provides a soft engagement with the chain, which results in an improved general user experience. A slip clutch may also give feedback to the user when the saw chain is overloaded, for example by the user pressing the saw chain too hard against the material to be cut since, for a centrifugal clutch of slip type, it is typically possible to hear when the clutch is slipping. The audible and/or haptic feedback generated by the slipping may prompt the user to release the load, and with the torque provided by the electric motor at low rotational speeds, the electric motor may restart the chain directly, immediately bringing back the chainsaw to a high cutting efficiency. When slipping, the electric motor does not come to a full stop even if the operator presses the saw chain too hard against the material to be cut. Still further, some electric motor types provide only a low to moderate torque at standstill, whereas already at very low rotational speeds, the torque reaches its maximum. The slip clutch thereby enables a freer selection of the electric motor type because the torque provided by the electric motor will not drop at an extent corresponding to a rotational speed drop to zero.

According to embodiments, the transmission arrangement may be configured to provide a transmission ratio of 1:1 between the electric motor and the saw chain drive sprocket. Thereby, any transmission losses are kept at a minimum, which maximizes battery life. In a particularly compact arrangement, the rotor of the electric motor, the saw chain drive sprocket, the drive member of the clutch and the brake drum may be configured to rotate about the same rotation axis, i.e. the rotation axis of the clutch drum. In a particularly compact arrangement, the clutch drum and the brake drum may be rotatably mounted on an output shaft of the electric motor.

According to embodiments, the brake drum may be rotatable in relation to an output shaft of the motor. For example, the brake drum may be rotatably arranged on a bearing about the output shaft of the motor. According to further embodiments, the clutch drum and the brake drum may be rotatably arranged on a single bearing. Said single bearing may comprise separately rotatable axial sections for the clutch drum and the brake drum, respectively.

It is noted that embodiments of the invention may be embodied by all possible combinations of features recited in the claims, as well as of the further embodiments defined hereinabove. Moreover, neither the second keyed interface, which rotationally locks the saw chain drive sprocket to the clutch drum, nor the third keyed interface, which rotationally locks the worm screw to the brake drum, is dependent on there being a first keyed interface between the clutch drum and the brake drum. Clear benefits are provided by each of the respective keyed interfaces individually. Hence, according to further aspects, there is provided a handheld battery-powered chainsaw as defined in any of the embodiments hereinabove, albeit without the first keyed interface; the brake drum can be rotationally fixed to the clutch drum in any other suitable manner than via said first keyed interface, or even omitted.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a plan view of a handheld battery-powered chainsaw;

FIG. 2 is a perspective view of the chainsaw of FIG. 1 with a chain sprocket cover removed to expose a transmission arrangement;

FIG. 3A is a perspective view of an electric motor of the chainsaw of FIG. 2 connected to the transmission arrangement of FIG. 2;

FIG. 3B is a plan view of the electric motor and transmission arrangement of FIG. 3A;

FIG. 4 is a magnified view of an interface between a saw chain, a saw chain drive sprocket, and a guide bar of the chainsaw of FIG. 1, the view substantially corresponding to a section taken along the line IV-IV of FIG. 3B;

FIG. 5 is an exploded view in perspective of the electric motor and transmission arrangement of FIGS. 3A and 3B;

FIG. 6 is a section view of the electric motor and transmission arrangement of FIGS. 3A and 3B, wherein the section is taken along the line VI-VI of FIG. 3B;

FIG. 7A is an exploded view of the transmission arrangement and an axial end of an output shaft of the electric motor of FIGS. 3A and 3B; and

FIG. 7B is a section of the transmission arrangement and the axial end of the output shaft of FIG. 7A, the section taken along the line VI-VI of FIG. 3B.

All the figures are schematic, not necessarily to scale, and generally only show parts which are necessary in order to elucidate the embodiments, wherein other parts may be omitted.

### DETAILED DESCRIPTION OF THE EXEMPLARY EMBODIMENTS

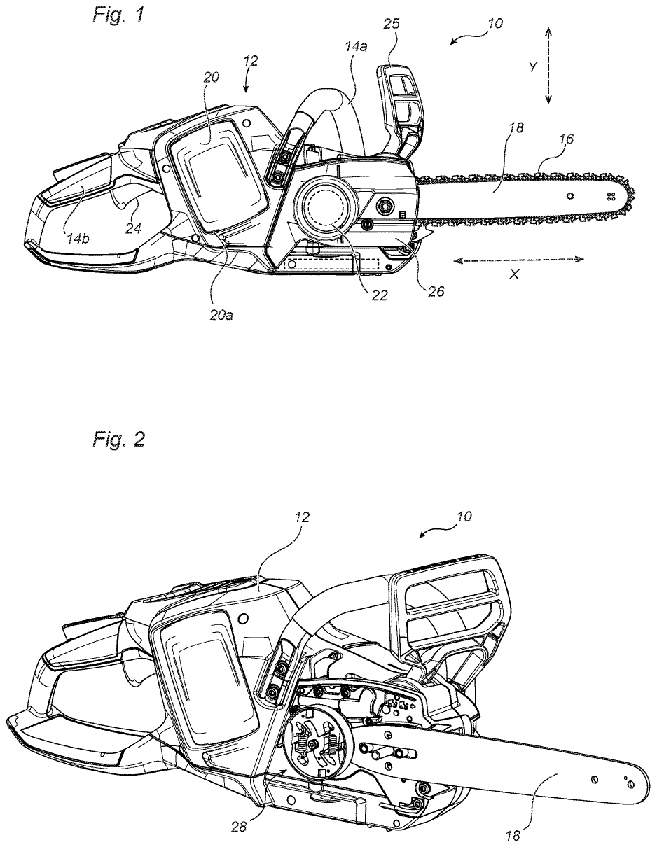

FIG. 1 illustrates a handheld battery-powered chainsaw 10. The chainsaw 10 comprises a chainsaw body 12 provided with a pair of handles 14a, 14b, by means of which an operator (not illustrated) may hold and operate the chainsaw 10. The pair of handles comprises a front handle 14a, typically for holding with the left hand, and a rear handle 14b, typically for holding with the right hand. A cutting assembly comprising a saw chain 16, and an elongate guide bar 18 guiding the saw chain 16 in an elongate loop, extends from a front end of the chainsaw body 12 along a longitudinal axis X of the chainsaw 10, which longitudinal axis X is defined by the longitudinal axis of the guide bar 18. A vertical axis Y of the chainsaw is perpendicular to the longitudinal axis X, and parallel to the extension plane of the guide bar 18. The chainsaw 10 further comprises a removable battery 20 in a battery compartment 20a, an electric motor 22 (only schematically indicated by a broken-line circle in FIG. 1), and a finger-operated trigger 24 permitting the operator to selectively mobilize the saw chain 16 using the electric motor 22. The trigger 24 extends downwards from a bottom face of the rear handle 14b, and is movable between a depressed position (not illustrated), responsive to which the electric motor 22 is operated to move the saw chain 16, and a released position (illustrated), responsive to which the saw chain 16 is stopped. A hand guard 25 in front of the front handle 14a is operatively connected to a brake arrangement (not illustrated) for stopping the saw chain 16 in case of a kick-back. The brake arrangement is a safety feature which operates independent of the position of the trigger 24.

FIG. 2 illustrates the chainsaw 10 without the saw chain 16 (FIG. 1), and with a chain sprocket cover 26 (FIG. 1) removed to expose the attachment of the guide bar 18 to the chainsaw body 12, along with a transmission arrangement 28 transmitting rotary power from the electric motor 22 (FIG. 1) to the saw chain 16 (FIG. 1).

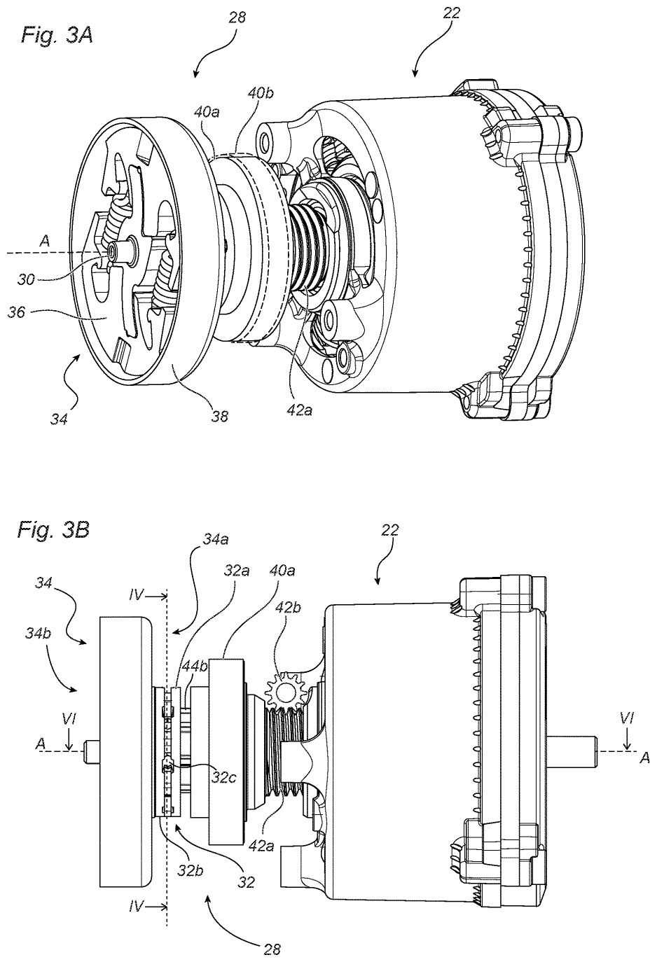

FIGS. 3A and 3B illustrate the electric motor 22 and the transmission arrangement 28 in greater detail. The transmission arrangement 28 comprises, inter alia, an output shaft 30 of the electric motor 22, a saw chain drive sprocket 32 (FIG. 3B), and a centrifugal clutch 34. The centrifugal clutch 34 comprises a drive member 36, which rotates with and receives rotary power from the electric motor 22 via the output shaft 30, and a clutch drum 38 which rotates with and transmits rotary power to the saw chain drive sprocket 32. The centrifugal clutch is of slip clutch type, i.e. at least initially during clutch engagement, slippage is enabled between the drive member 36 the clutch drum 38. This results in a gradual engagement between the drive member 36 and the clutch drum 38.

The transmission arrangement 28 further comprises a brake drum 40a configured to cooperate with a brake band 40b operated by the hand guard 25. In the event of a kick-back, the hand guard 25 actuates the brake band 40b to apply a clamping force on the radially outer face of the brake drum 40a. The transmission arrangement 28 further comprises a worm screw 42a of a worm drive for driving, via a worm wheel 42b (FIG. 3B), a saw chain oil pump (not illustrated).

In the view of FIG. 3A, the brake band 40b is only highly schematically indicated in broken lines. The saw chain drive sprocket 32, the brake drum 40a and the worm screw 42a are rotationally locked to the clutch drum 38 of the centrifugal clutch 34. Clearly, the worm screw 42a is highly optional; saw chain oil may, if necessary, be pumped by any other suitable means instead.

The drive member 36, the clutch drum 38, the saw chain drive sprocket 32 and the brake drum 40a are all configured to rotate concentrically about a single rotation axis A, which is perpendicular to the longitudinal direction X (FIG. 1) as well as to the vertical axis Y (FIG. 1). As may be apparent from the configuration of the transmission arrangement 28, the transmission arrangement 28 provides a transmission ratio of 1:1 between the electric motor 22 and the saw chain drive sprocket 32. The saw chain drive sprocket 32 is of rim type, i.e. it comprises a pair of support rims 32a, 32b disposed on opposite sides, along the rotation axis A, of a drive centre 32c.

As illustrated in FIG. 3B, the centrifugal clutch 34 has a proximal side 34a facing the electric motor 22 and a distal side 34b facing away from the electric motor 22, and the saw chain drive sprocket 32 is rigidly connected to the clutch drum 38 of the centrifugal clutch 34 on the proximal side 34a of the centrifugal clutch 34. This arrangement positions the saw chain drive sprocket 32 comparatively close to the lateral centre of the chainsaw 10 along the rotation axis A.

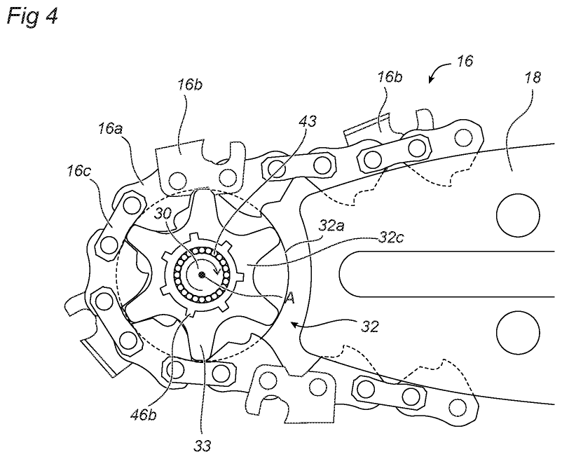

FIG. 4 schematically illustrates the saw chain drive sprocket 32, a short section of the saw chain 16, and a proximal end of the guide bar 18, in the section indicated by the line IV-IV of FIG. 3B. The saw chain drive sprocket 32 is rotated by the motor 22 (FIG. 1) via the transmission arrangement 28 (FIGS. 3A and 3B), and drivingly engages with the saw chain 16 to move the saw chain 16 along the guide bar 18. The saw chain 16 comprises drive links 16a meshing with drive teeth 33 of the drive centre 32c of the saw chain drive sprocket 32. Cutter links 16b are provided with cutting teeth adapted to shave off wood chips from the material being cut, and the cutter links 16b and tie straps 16c hold the drive links 16a together. The support rims 32a, 32b (FIG. 3B), which in the illustrated embodiment are circular as seen along the rotation axis A, radially support the cutter links 16b and tie straps 16c to provide smooth running of the chain, and by virtue of axially straddling the drive links 16a also axially lock the saw chain 16 to the saw chain drive sprocket 32.

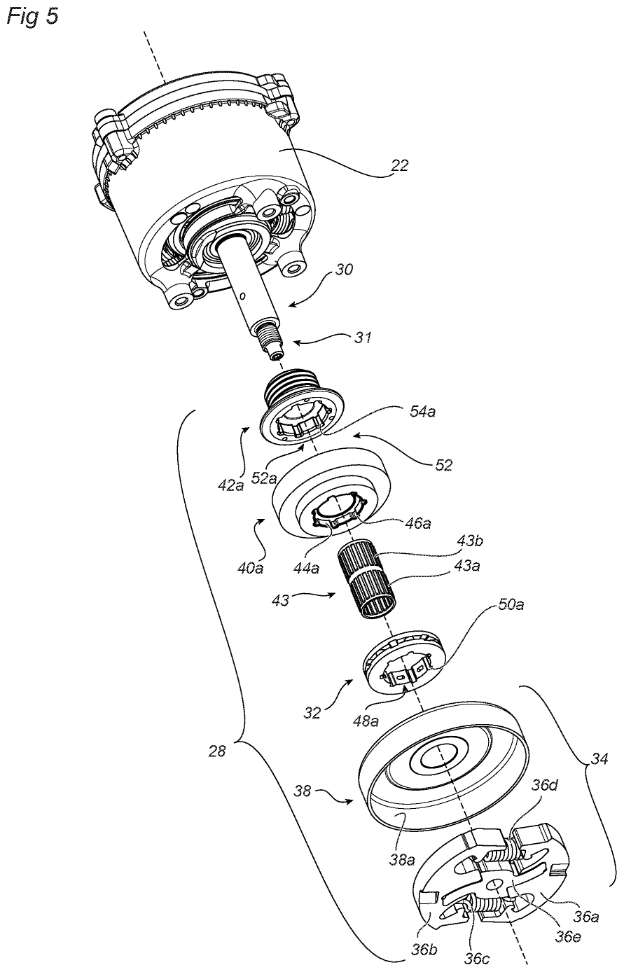

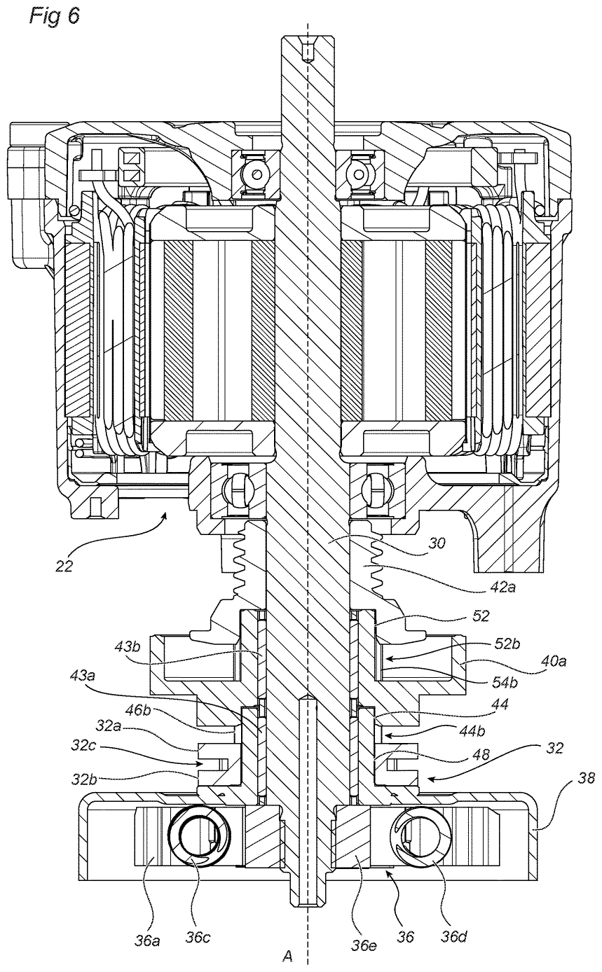

FIG. 5 is an exploded view in perspective of the electric motor 22 and the transmission arrangement 28, whereas FIG. 6 illustrates the same assembly in a section taken along the motor rotation axis A. The output shaft 30 has an axial end 30a provided with a clutch connection interface 31 for drivingly engaging with the drive member 36 of the centrifugal clutch 34. The clutch connection interface 31 is configured as a left-handed thread configured to engage with a mating thread (not illustrated) in a centre bore of the drive member 36.

The drive member 36 comprises a pair of friction shoes 36a, 36b held together by a pair of coil springs 36c, 36d. The friction shoes 36c, 36d are axially held in place by a friction shoe guide 36e, so as to be guidedly movable in a radial direction with regard to the rotation axis A. The friction shoe guide 36e is attached to the clutch connection interface 31 of the output shaft 30 in a rotationally fixed manner. Responsive to rotation of the drive member 36, the friction shoes 36a, 36b will be pressed radially outwards, against the bias of the coil springs 36c, 36d, by the centrifugal effect on the mass of the friction shoes 36a, 36b, to gradually engage with a radially inner clutch engagement face 38a of the clutch drum 38. A bearing 43 on the output shaft 30 of the electric motor 22 enables the output shaft 30, when the centrifugal clutch 34 is in a disengaged state, to rotate without rotating the clutch drum 38, the saw chain drive sprocket 32, the brake drum 40a or the worm screw 42a. The bearing 43 has a first axial section 43a which rotatably supports the clutch drum 38, and a second axial section 43b which rotatably supports the brake drum 40a.

The clutch drum 38 is rotationally locked to the brake drum 40a via a first keyed interface 44 (FIG. 6). The first keyed interface 44 comprises a female key interface part 44a, comprising grooves 46a formed in a radially inwards facing surface of the brake drum 40a, and a male key interface part 46b (FIG. 6) comprising splines 46b on the clutch drum 38 configured to mate with the grooves 46a.

The saw chain drive sprocket 32 is rotationally locked to the brake drum 40a and the clutch drum 30 via a second keyed interface 48 (FIG. 6). The second keyed interface 48 comprises a female key interface part 48a. The female key interface part 48a comprises grooves 50a formed in a radially inwards facing surface of the saw chain drive sprocket 32, which mate with the splines 46b of the male key interface part 44b of the clutch drum 38. As apparent from the section of FIG. 6, the second keyed interface 48 enables axial translation of the saw chain drive sprocket 32 along the male interface key part 44b of the clutch drum 38 when the transmission arrangement 28 is in a fully assembled state.

The worm screw 42a is rotationally locked to the clutch drum 38, the saw chain drive sprocket 32 and the brake drum 40a via a third keyed interface 52 (FIG. 6). The third keyed interface 52 comprises a female key interface part 52a, comprising grooves 54a formed in a radially inwards facing surface of the worm screw 42a, and a male key interface part 52b (FIG. 6) comprising splines 54b on the brake drum 40a.

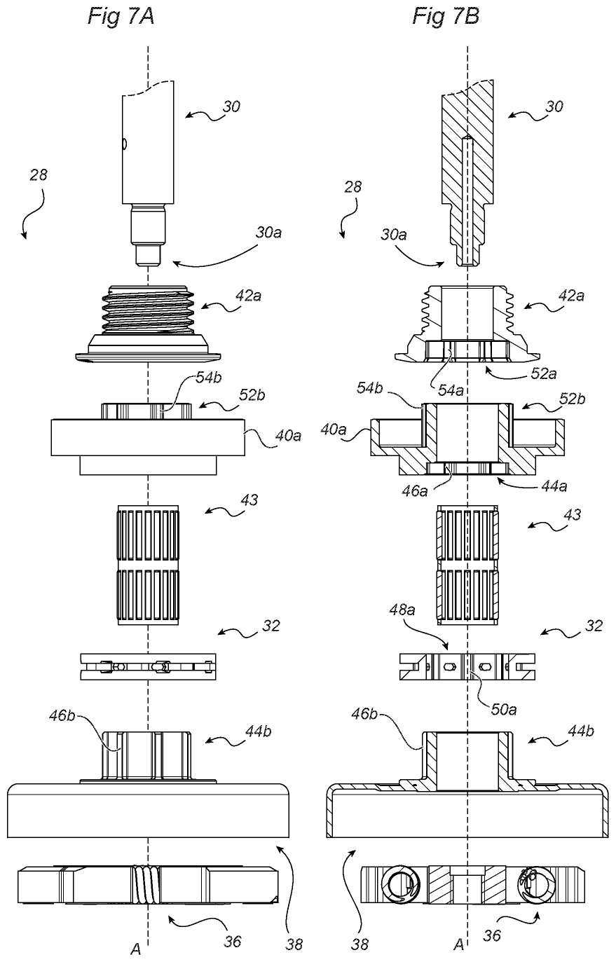

FIG. 7A is an exploded view of the transmission arrangement 28 and the axial end 30a of the output shaft 30, and 7B illustrates a section through the exploded view, taken along the section plane of FIG. 6. The views of FIGS. 7A and 7B more clearly illustrate the respective key interface parts 44a, 44b, 48a, 52a, 52b of the first, second and third keyed interfaces 44, 48 and 52.

In an alternative embodiment (not illustrated), the male key interface part 44b of the clutch drum 38 may extend all the way through the brake drum 40a, to directly engage with the female key interface part 52b of the of the worm screw.

The invention has mainly been described above with reference to a few embodiments. However, as is readily appreciated by a person skilled in the art, other embodiments than the ones disclosed above are equally possible within the scope of the invention, as defined by the appended patent claims. For example, the invention has been described with reference to a chainsaw of rear-handle type. However, it will be appreciated that the teachings herein are equally applicable to a chainsaw of top-handle type. The keyed interfaces have each been described as comprising a respective male key interface part and a respective female key interface part. Clearly, the male and female key interface parts may be swapped with each other, such that for example the clutch drum has a female key interface part and the saw chain drive sprocket has a male key inter face part. Alternatively, each respective key interface part may comprise a respective male element and a respective female element, which are configured to mate with respective female and male elements of the mating key interface part.

In the claims, the word “comprising” does not exclude other elements or steps, and the indefinite article “a” or “an” does not exclude a plurality.

1. A handheld battery-powered chainsaw comprising:
an electric motor; and
a transmission arrangement coupled to the electric motor, the transmission arrangement comprising a saw chain drive sprocket configured to mesh with and drive a saw chain, wherein the electric motor is configured to drive the saw chain via the transmission arrangement, wherein the transmission arrangement further comprises
a centrifugal clutch comprising a drive member configured to receive rotary power from the electric motor and a clutch drum configured to variably engage with the drive member to be rotated by the drive member about a rotation axis and thereby transmit rotary power to the saw chain; and
a brake arrangement comprising a brake drum rotationally locked, with regard to the rotation axis, to the clutch drum via a first keyed interface.

2. The handheld battery-powered chainsaw according to claim 1, wherein the first keyed interface is shaped to enable axial translation, along the rotation axis, of the brake drum in relation to the clutch drum.

3. The handheld battery-powered chainsaw according to claim 1, wherein the first keyed interface comprises splines.

4. The handheld battery-powered chainsaw according to claim 1, wherein the clutch drum comprises a male key interface part, and the brake drum comprises a female key interface part mating with the male key interface part of the clutch drum.

5. The handheld battery-powered chainsaw according to claim 4, wherein the saw chain drive sprocket is rotationally locked to the brake drum and the clutch drum via a second keyed interface.

6. The handheld battery-powered chainsaw according to claim 5, wherein the second keyed interface is configured to enable axial translation of the saw chain drive sprocket in relation to the clutch drum.

7. The handheld battery-powered chainsaw according to claim 1, wherein the saw chain drive sprocket comprises a female key interface part mating with a male key interface part of one of the clutch drum and the brake drum.

8. The handheld battery-powered chainsaw according to claim 5, wherein the male key interface of the clutch drum mates with a female key interface part of the saw chain drive sprocket.

9. The handheld battery-powered chainsaw according to claim 1, wherein the sprocket is a rim-type sprocket.

10. The handheld battery-powered chainsaw according to claim 1, wherein the saw chain drive sprocket is arranged at an axial position, along the rotation axis, between the clutch drum and the electric motor.

11. The handheld battery-powered chainsaw according to claim 1, wherein the saw chain drive sprocket is arranged at an axial position, along the rotation axis, between the clutch drum and the brake drum.

12. The handheld battery-powered chainsaw according to claim 1, wherein the brake drum is arranged at an axial position, along the rotation axis, between the clutch drum and the electric motor.

13. The handheld battery-powered chainsaw according to claim 1, wherein the brake drum is arranged at an axial position, along the rotation axis, between the saw chain drive sprocket and the electric motor.

14. The handheld battery-powered chainsaw according to claim 1, wherein the transmission arrangement further comprises a worm screw in driving engagement with a saw chain oil pump, wherein the worm screw is rotationally locked to the brake drum, the clutch drum and the saw chain drive sprocket via a third keyed interface.

15. The handheld battery-powered chainsaw according to claim 1, wherein the centrifugal clutch is a slip clutch.

16. The handheld battery-powered chainsaw according to claim 1, wherein the transmission arrangement is configured to provide a transmission ratio of 1:1 between the electric motor and the saw chain drive sprocket.

17. The handheld battery-powered chainsaw according to claim 1, wherein the brake drum is rotatable in relation to an output shaft of the motor.
